(19) United States
(12) Patent Application Publication
(10) Pub. No.: US 2025/0340966 A1
(43) Pub. Date: Nov. 6, 2025

(54) Heat treatment line for a hot strip

(71) Applicant: SMS group GmbH, Mönchengladbach (DE)

(72) Inventors: Frank MASCHLER, Duisburg (DE); Markus LANGEJÜRGEN, Wipperfürth (DE); Amedeo DI GIOVANNI, Crisnee (BE); Michael HAENTJES, Mönchengladbach (DE)

(73) Assignee: SMS group GmbH, Mönchengladbach (DE)

(21) Appl. No.: 18/855,434

(22) PCT Filed: Apr. 6, 2023
(86) PCT No.: PCT/EP2023/059277

§ 371 Date: Oct. 9, 2024

(30) Foreign Application Priority Data
Apr. 11, 2022 (DE) 10 2022 203 612.3
Jun. 23, 2022 (DE) 10 2022 206 330.9

(51) Int. Cl. C21D 9/60; C21D 1/42; C21D 9/573; C23G 3/02

(52) U.S. Cl. CPC C21D 9/60; C21D 1/42; C21D 9/573; C23G 3/028

(57) ABSTRACT

The present application relates to an annealing device (1), in particular an annealing furnace, for the oxidation-free heat treatment N) of a hot-rolled steel strip (3), which is provided for the production of an electrical steel strip and/or stainless steel strip, a treatment line (2) for the continuous pickling and oxidation-free annealing of a hot-rolled steel strip (3), and a method for the continuous pickling and oxidation-free annealing of a hot-rolled steel strip (3).

### CROSS-REFERENCE TO RELATED APPLICATION

This application is a national stage application, filed under 35 U.S.C. § 371, of International Patent Application PCT/EP2023/059277, filed on Apr. 6, 2023, which claims the benefit of German Patent Applications DE 10 2022 203 612.3, filed on Apr. 11, 2022, and DE 10 2022 206 330.9, filed on Jun. 23, 2022.

### TECHNICAL FIELD

The present disclosure relates to an annealing device, in particular an annealing furnace, for the oxidation-free heat treatment of a hot-rolled steel strip, which is provided for the production of electrical steel strip and/or stainless steel strip. The disclosure further relates to a treatment line for the continuous pickling and oxidation-free annealing of a hot-rolled steel strip, and to a method for the continuous pickling and oxidation-free annealing of a hot-rolled steel strip.

### BACKGROUND

Electrical steel strip is one of the most important soft magnetic materials for magnetic cores and usually consists of an iron-silicon alloy. It is currently divided into two different electrical steel strip grades. So-called “non-grain-oriented” electrical steel strip is equally magnetizable in all directions and is mainly used in rotating electrical machines. In contrast, so-called “grain-oriented” electrical steel strip has a preferred direction of magnetizability and is generally used for power transformers, distribution transformers and higher-value small transformers.

The production of the electrical steel strips, as disclosed for example in US 2017/0283903 A1, is usually effected by adding a specific metallic steel composition containing (in % by weight) usually 2.5 to 4.0% Si, 0.010 to 0.100% C, up to 0.150% Mn, up to 0.065% Al and up to 0.0150% N, and in each case optionally 0.010 to 0.3% Cu, up to 0.060% S, up to 0.100% P, up to 0, 2% As, Sn, Sb, Te and Bi, the remainder being iron and unavoidable impurities, which is then cast into a starting material, such as a slab, thin slab or cast strip, and immediately hot-rolled into a so-called “hot strip.” The hot-rolled steel strip is then subjected to an annealing treatment and, in a further step, cold-rolled into a so-called “cold strip.” In order to achieve the advantageous magnetic properties, the cold strip is then annealed in a continuous annealing and coating line to recrystallize it and then coated with an insulating coating.

For the annealing treatment of the hot-rolled steel strip, the scale layer on the surface is usually tolerated, since further oxidation in the open-heated annealing furnaces and thus a further scale build-up (so-called “annealing scale”) is unavoidable. In the prior art, the hot-rolled steel strip is therefore initially subjected to an annealing treatment and subsequently to a descaling process, in order to provide a scale-free hot strip for the following cold rolling process. The combination of annealing and pickling is known as a so-called “annealing pickling line.” Such a line is also referred to as a so-called “APL” (annealing pickling line) in English.

The descaling process initially involves mechanical pre-descaling, which is subsequently supplemented by a chemical pickling process. Mechanical descaling is usually carried out by means of a blasting device, as a result of which the surface of the hot strip is roughened in such a manner that the roughness created is retained to a considerable extent after cold rolling and then impairs the magnetic properties of the grain-oriented or non-oriented electrical steel strip.

The annealing furnaces known from the prior art consist of a heating and holding part, and a cooling part following it, which comprises an air cooling section along with a water cooling section. In the heating part, the hot strip is heated openly with fossil fuels using gas burners, as a result of which high CO2 emissions arise. An annealing device of this type is known, for example, from U.S. Pat. No. 5,472,528, which also teaches the use of induction apparatuses arranged either upstream or downstream of at least one traditional heating device in order to improve the inertia of traditional heating means. In the holding part, the hot strip is then electrically heated in a nitrogen atmosphere. In the following air cooling section, the hot strip is initially subjected to slow cooling and then to more intensive water cooling. During slow cooling, the hot strip is further oxidized. The scale particles formed in this process are discharged with the exhaust air, such that it has to be extensively filtered. Additional scale is also produced during intensive water cooling, which must be removed from the cooling water, usually via scale settling tanks.

Therefore, there is still a desire among experts to improve methods of this type.

### SUMMARY

The present application presents an apparatus for the oxidation-free heat treatment of a hot-rolled steel strip that is provided for the production of electrical steel strip and/or stainless steel strip, which permits improved process control compared with the prior art.

Furthermore, the present application provides a method, improved over the prior art, for the continuous pickling and oxidation-free annealing of a hot-rolled steel strip, which is provided for the production of electrical steel strip and/or stainless steel strip.

The improvement is achieved by an annealing device, in particular an annealing furnace, for the oxidation-free heat treatment of a hot-rolled steel strip as disclosed herein, by a treatment line for the continuous pickling and oxidation-free annealing of a hot-rolled steel strip as disclosed herein, and by a method for the continuous pickling and oxidation-free annealing of a hot-rolled steel strip as disclosed herein.

The annealing device, in particular an annealing furnace, for the oxidation-free heat treatment of a hot-rolled steel strip, which is provided for the production of electrical steel strip and/or stainless steel strip, comprises a hermetically sealed furnace chamber, which has a heating section, optionally a holding section following the heating section, along with a cooling section following the heating section, optionally a cooling section following the holding section, wherein the heating section has a plurality of inductors connected in series, and wherein the cooling section comprises a cooling device, via which a reducing protective gas for cooling the hot-rolled steel strip can be introduced into the cooling section.

The treatment line for the continuous pickling and oxidation-free annealing of a hot-rolled steel strip, which is provided for the production of electrical steel strip and/or stainless steel strip, comprises a pre-treatment device, in which the hot-rolled steel strip can be pickled, and the annealing device, which is arranged downstream of the pre-treatment device in the direction of strip travel.

According to the method for the continuous pickling and oxidation-free annealing of a hot-rolled steel strip, which is provided for the production of electrical steel strip and/or stainless steel strip, the hot-rolled steel strip is, optionally after an unwinding step, initially fed to a pre-treatment device and pickled therein; and is subsequently fed as pickled steel strip to an annealing device and, under a reducing protective gas atmosphere, is initially inductively heated to an annealing temperature via a plurality of inductors connected in series, then annealed and subsequently quenched and/or cooled using a reducing protective gas.

The steel strip used to produce electrical steel strip is preferably a steel that (in % by weight) typically contains 2.5 to 4.0% Si, 0.010 to 0.100% C, up to 0.150% Mn, up to 0.065% Al and up to 0.0150% N, along with in each case optionally 0.010 to 0.3% Cu, up to 0.060% S, up to 0.100% P, up to 0.2% in each case As, Sn, Sb, Te and Bi, the remainder being iron and unavoidable impurities.

The annealing device enables complete heat treatment under a reducing protective gas atmosphere, which has a reducing effect on the hot strip used and thus enables an oxide-free steel strip surface. A very high power density can be achieved via the inductors, as a result of which the heating part can be considerably shortened compared to the annealing furnaces known from the prior art. Accordingly, conventional gas burners or radiant heating elements are not provided. In the same manner, this enables economical operation of the annealing device under a reducing protective gas atmosphere. Furthermore, a reducing protective gas, such as hydrogen, has an improved convective heat transfer compared to atmospheric air, as a result of which high cooling rates, for example up to 50 K/s, can be achieved within the cooling section. These either result in a shorter overall length of the annealing device, for example, for non-grain-oriented electrical steel, or they are particularly advantageous for quality reasons, for example to achieve intensive cooling of grain-oriented electrical steel strip or stainless steel.

In this respect, the annealing device enables a pickling treatment to be carried out prior to the heat treatment, which has a particularly advantageous effect on the heat treatment process of the hot strip, since the use of scale breakers and/or blasting devices can be dispensed with. As a result, the pickling times can be shortened, and thus output can be increased. In addition, the roughness of the surface can be reduced, as a result of which the magnetic properties of the electrical steel strip are improved.

Further advantages of the invention are:
a) Avoidance of CO2 emissions;
b) Oxidation-free heat treatment;
c) Shorter length of the annealing device;
d) Avoidance of open cooling water;
e) Reduction of dust emissions.

Further advantageous embodiments of the invention are indicated in the dependent formulated claims. The features listed individually in the dependent formulated claims can be combined with one another in a technologically useful manner and can define further embodiments of the invention. In addition, the features indicated in the claims are further specified and explained in the description, wherein further preferred embodiments of the invention are shown.

At this point, it should be noted that the annealing device is neither intended for nor suitable for a hot strip galvanizing line (also known as a pickling and galvanizing line (PGL)).

In this respect, it is advantageously provided that the annealing device has a horizontal design. Furthermore, it is preferably provided that the cooling section and/or the exit sluice of the annealing device do not open into a coating device.

In an advantageous design variant of the method, the pickled steel strip is initially heated in a heating section of the annealing device to an annealing temperature of at least 800° C. at a heating rate of at least 20 K/s, more preferably at a heating rate of at least 25 K/s, even more preferably at a heating rate of at least 30 K/s. However, the heating rate should not exceed a maximum of 60 K/s, more preferably 55 K/s, and most preferably a value of 50 K/s.

Here, it is advantageously provided that the pickled steel strip, which has accordingly been completely freed from scale, is heated in two separate stages within the heating section. Preferably, for this purpose the annealing device comprises a first stage with a plurality of longitudinal field inductors connected in series, in which the pickled steel strip is initially heated to a temperature of at least 650° C. In contrast, the annealing device in the second stage has a plurality of transverse field inductors connected in series, by means of which the steel strip is then heated to the annealing temperature of at least 800° C.

The respective number of inductors, with which heating rates of up to 100 K/(s*mm strip thickness) can usually be achieved, within the annealing device depends on the required total output and can accordingly vary between 1 and 20.

In favor of a good coupling of the magnetic field, the passage gap for the steel strip should not be too large. Therefore, in the heating section, this advantageously amounts to a vertical extension of ≤300 mm, more preferably a vertical extension of ≤250 mm, and most preferably a vertical extension of ≤200 mm.

In order to keep heat losses within the heating section as low as possible, a further advantageous design variant provides for the passage gap to be delimited by a thermal insulation layer arranged below and above the steel strip feed-through level and provided with a gas-tight enclosure on the outside.

If the hot-rolled steel strip is subsequently provided for the production of a grain-oriented and a non-grain-oriented electrical steel strip, it is preferably annealed in a holding section following the heating section at a temperature in the range of 800-1200° C. for at least 60 s.

In a preferred design variant, the annealing device can therefore have a holding section, which particularly preferably comprises three individual holding section stages. The first holding section stage directly follows the heating section, wherein the second holding section stage is directly upstream of the cooling section. On the one hand, both holding section stages comprise conventional electric heating elements, which can be arranged below the steel strip feed-through level. Furthermore, the two holding section stages comprise conventional air-flow cooling jet tubes, which can be arranged above the steel strip feed-through level, for example. The third holding section stage is arranged within the holding section between the first and second holding section stages and, unlike these, has no cooling jet tubes, but only the electrical heating elements.

After the annealing treatment, the steel strip is quenched and/or cooled using a reducing protective gas. In an advantageous design variant of the method, the annealed steel strip can be cooled at an initial cooling rate of at least 15 K/s in a cooling section of the annealing device directly following the heating section. In this design variant, the annealing device therefore only comprises a heating section along with a cooling section.

In a further advantageous design variant of the method, the annealed steel strip can be cooled in a cooling section of the annealing device directly following the holding section. In this case, the initial cooling rates amount to at least 40 K/s.

Advantageously, the cooling device comprises at least one nozzle, via which the reducing protective gas can be blown onto the steel strip. More preferably, however, the cooling device comprises at least one nozzle arranged above and at least one nozzle arranged below a steel strip feed-through level. The at least one nozzle can be designed as a slotted nozzle that extends within the cooling section transversely to a transport direction of the steel strip. In a further advantageous design variant, the cooling device can have at least one distributor arranged above and below a steel strip feed-through level, which comprises a plurality of perforated nozzles. The respective nozzle is advantageously designed in such a manner that an exit speed of the reducing protective gas of 50 to 150 m/s can be achieved.

Furthermore, it is advantageously provided that the cooling device comprises at least one blower device, via which the reducing protective gas can be fed to the at least one nozzle, optionally to the at least one distributor. Furthermore, the cooling device can comprise at least one heat exchanger, via which the reducing protective gas blown into the cooling section can be cooled.

In a particularly advantageous design variant, it is provided here that the cooling device has a circulation system in which the at least one nozzle and/or the at least one distributor together with nozzles, the at least one blower device along with the at least one heat exchanger are interconnected, particularly preferably in such a manner that the reducing protective gas is blown into the cooling section, via the at least one blower device along with the at least one nozzle and/or the at least one distributor and nozzles, particularly preferably onto the steel strip, and is extracted again via the at least one blower device and cooled by means of the at least one heat exchanger.

Using the reducing protective gas, a cooling system of this type enables convective heat transfers of 500 to 800 W/m²K in relation to the steel strip surface, as a result of which high cooling rates of >40 K/s can be achieved.

Preferably, a hydrogen-rich gas is used as the reducing protective gas, which has a hydrogen content of at least 30% by volume, more preferably a hydrogen content of at least 50% by volume, even more preferably a hydrogen content of at least 75% by volume.

The feeding of the reducing protective gas into the furnace chamber can be effected at various points in the annealing device. However, it is preferably provided that the reducing protective gas is fed to the holding section in order to achieve the maximum reduction effect at the maximum strip temperature. In another preferred design variant, the reducing protective gas can be fed to the cooling section to increase the heat transfer.

### DESCRIPTION OF FIGURES

The invention and the technical environment are explained in more detail below with reference to the figures. It should be noted that the invention is not intended to be limited by the exemplary embodiments shown. In particular, unless explicitly shown otherwise, it is also possible to extract partial aspects of the facts explained in the figures and combine them with other components and findings from the present description and/or figures. In particular, it should be noted that the figures and in particular the size relationships shown are only schematic. Identical reference signs designate identical objects, such that explanations from other figures can be used as a supplement if applicable. The following are shown:

### Brief Description of the Drawings

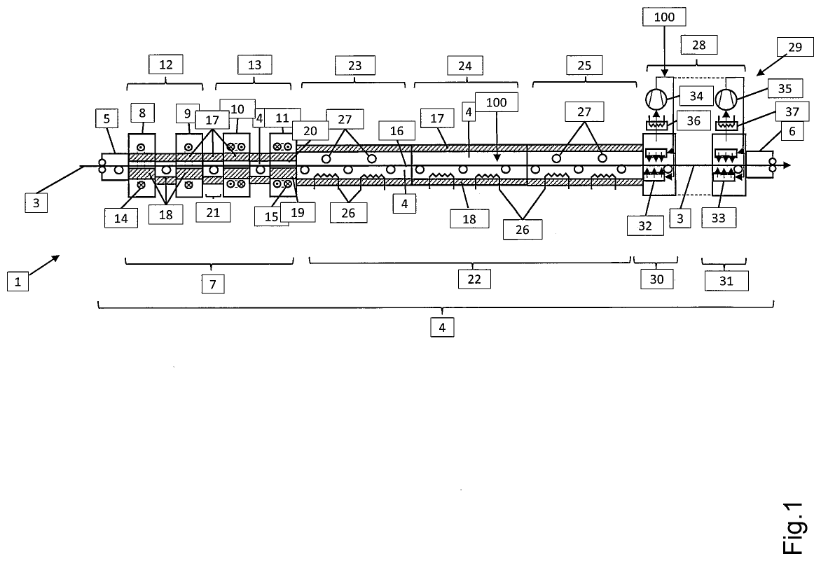

FIG. 1 a design variant of the annealing device,

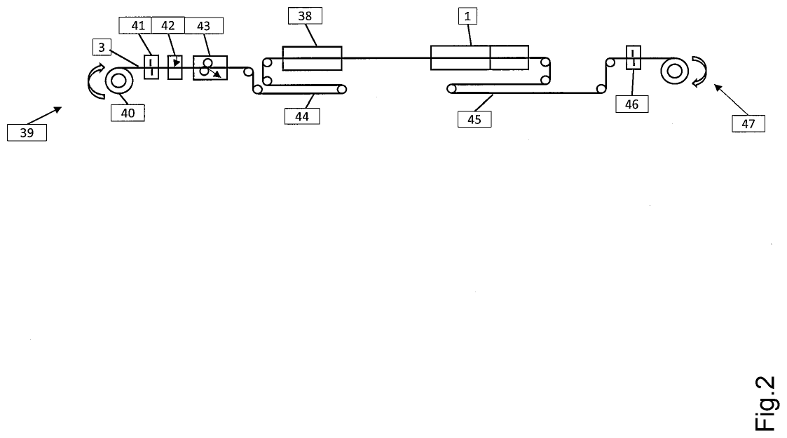

FIG. 2 a design variant of the treatment line,

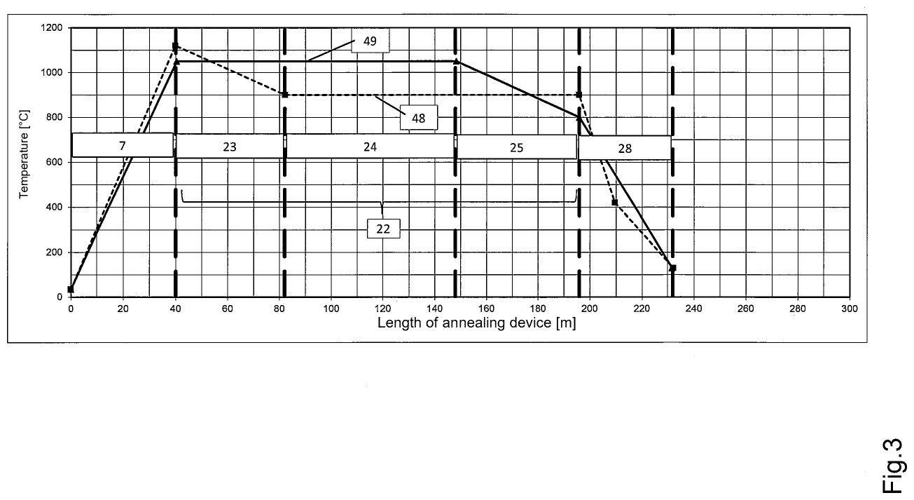

FIG. 3 a heat treatment temperature profile for a grain-oriented and a non-grain-oriented electrical steel strip, and

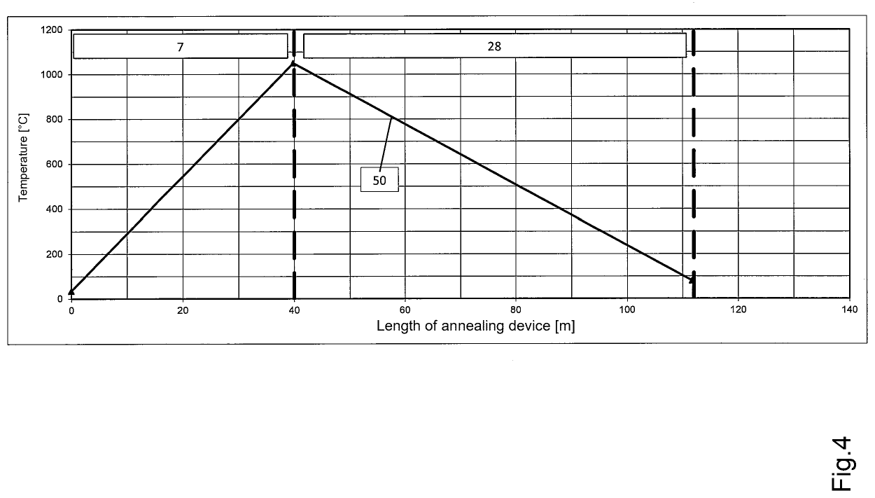

FIG. 4 a heat treatment temperature profile for a stainless steel strip.

### DETAILED DESCRIPTION

FIG. 1 shows a design variant of the annealing device 1, which is provided for use in a treatment line 2 for the continuous pickling and oxidation-free annealing of a hot-rolled steel strip 3 (see FIG. 2). Steel strips 3 of this type serve for the production of electrical steel strip and/or stainless steel strip and are usually fed to a cold rolling process after annealing/heat treatment.

The annealing device 1 shown in the present design variant comprises a hermetically sealed furnace chamber 4, which is operated under a reducing protective gas atmosphere. The feeding of the reducing protective gas can be effected into the furnace chamber 4 at various points, as illustrated by reference number 100.

The furnace chamber 4 comprises an entry sluice 5, through which the hot-rolled steel strip 3 enters the furnace chamber 4, and an exit sluice 6, through which the then heat-treated steel strip 3 leaves the furnace chamber 4 again. Adjacent to the entry sluice 5, the annealing device 1 initially has a heating section 7, which comprises a plurality of inductors 8, 9, 10, 11 connected in series, wherein the inductors 8, 9 form a first stage 12 and the two inductors 10, 11 form a second stage 13 of the heating section 7.

Here, the inductors 8, 9 are designed as longitudinal field inductors and have corresponding longitudinal field inductor coils 14 for this purpose. In contrast, the inductors 10, 11 are designed as transverse field inductors, which have corresponding transverse field inductor coils 15. Furthermore, each of the inductors 8, 9, 10, 11 has a thermal insulation layer 17, 18 arranged below and above a steel strip feed-through level 16, which is provided with a gas-tight enclosure 19 on the outside. As can be seen from the illustration, a passage gap 20 is created in each of the inductors 8, 9, 10, 11 by the thermal insulation layers 17, 18, which in the present design variant has a vertical extension of 150 mm in favor of good coupling of the magnetic field. Roller stands 21 are also arranged between the individual inductors 8, 9, 10, 11, by means of which the strip sag of the steel strip 3 is delimited. In the present design variant, the roller stands 21 are also in each case provided with a thermal insulation layer 17, 18 arranged below and above the steel strip feed-through level 16, which is sealed off from the atmosphere on the outside by the gas-tight enclosure 19.

Furthermore, the annealing device 1 comprises a holding section 22 following the heating section 7, which has three holding section stages 23, 24, 25, wherein each of these holding section stages 23, 24, 25 is provided with electrical heating elements 26, which are arranged below the steel strip feed-through level 16. In the design variant shown here, the two outer holding section stages 23, 25 additionally comprise conventional air-flow cooling jet tubes 27, which are arranged above the steel strip feed-through level 16. As can also be seen from FIG. 1, the entire holding section 22 is also provided with a thermal insulation layer 17, 18 arranged below and above the steel strip feed-through level 16, which is sealed off from the atmosphere on the outside by the gas-tight enclosure 19. The holding section 22 is then followed by a cooling section 28, which comprises a cooling device 29. In the present design variant, the cooling device 29 has two separate cooling stages 30, 31, via which the annealed steel strip 3 can be intensively cooled/quenched with a reducing protective gas, such as hydrogen. For this purpose, each of the two cooling stages 30, 31 has a distributor 32, 33 arranged below and a distributor 32, 33 arranged above the steel strip feed-through level 16, which in each case is provided with a plurality of nozzles (not shown) aligned in the direction of the steel strip feed-through level 16. Here, each of the distributors 32, 33 is fluidically connected via a gas line to a blower device 34, 35, for example a fan, arranged outside the furnace chamber 4, via which the reducing protective gas can then be fed to them. Furthermore, each of the two separate cooling stages 30, 31 comprises a heat exchanger 36, 37, also arranged outside the furnace chamber 4, via which the reducing protective gas blown into the respective cooling stage 30, 31 of the cooling section 28 can be cooled. For this purpose, the respective cooling stage 30, 31 is fluidically connected to the respective blower device 34, 35 via a further gas line.

FIG. 2 shows by way of example a design variant of the treatment line 2, which comprises a pre-treatment device 38 along with the annealing device 1 arranged behind it in the direction of strip travel. In detail, the treatment line 2 shown comprises a first coil device 39, via which a hot strip coil 40 is initially uncoiled. The uncoiled hot-rolled steel strip 3 is then fed to a first cutting device 41, in order to create a clean edge for a subsequent welding process. After welding in a welding device 42, the steel strip 3 is fed to a trimming device 43, in which the strip edges of the steel strip 3 are trimmed. After passing through an inlet accumulator 44, the steel strip 3 enters the pre-treatment device 38, in which it is pickled, rinsed and subsequently dried. As pickled steel strip 3, it is then fed to the annealing device 1, in which it is initially heated to an annealing temperature in a reducing protective gas atmosphere, annealed and subsequently intensively cooled/quenched before being subsequently recoiled again via an outlet accumulator 45.

FIG. 3 shows a heat treatment temperature profile for a hot-rolled steel strip 3, which is provided for the production of a grain-oriented and a non-grain-oriented electrical steel strip 48, 49.

In the present exemplary embodiment, the hot-rolled steel strip 3 provided for the production of the grain-oriented electrical steel strip 48 has a width of 1280 mm and a strip thickness of 2300 μm and is subjected to an oxidation-free heat treatment in the annealing device 1 at a strip speed of 75 m/min. The hot-rolled steel strip 3 provided for the production of the non-grain-oriented electrical steel strip 49 has a width of 1280 mm and a strip thickness of 2600 μm and is subjected to an oxidation-free heat treatment in the annealing device 1 at a strip speed of 80 m/min.

The respective hot-rolled steel strip 3, previously pickled in the pre-treatment device 38, is fed through the entry sluice 5 into the furnace chamber 4, which has a reducing protective gas atmosphere. A hydrogen-rich gas that has a hydrogen content of 75% by volume is used as the reducing protective gas. The respective hot-rolled steel strip initially passes through the heating section 7, in which it is heated to the Curie temperature of 700° C. by means of the two longitudinal field inductors 8, 9. Above the Curie temperature, the steel strip typically loses its paramagnetic properties and is therefore heated until the respective annealing temperature of 1120° C. (grain-oriented electrical steel strip 48)/the annealing temperature of 1050° C. (non-grain-oriented electrical steel strip 49) is reached by means of the two transverse field inductors 10, 11.

Subsequently, the steel strip 3, heated to the annealing temperature, passes through the holding section 22, in which it is annealed according to a specific heat treatment profile. As can be seen from FIG. 3, the grain-oriented electrical steel strip 48 is slowly cooled to a temperature of 900° C. in the first holding stage 23, before it then passes through the second and third holding stages 24, 25 at 900° C. The non-grain-oriented electrical steel strip 49, on the other hand, initially passes through the two holding stages 23, 24 at the previously set annealing temperature of 1050° C. and is only slowly cooled to a temperature of 800° C. in the third holding stage 25.

The respective annealed steel strip 3 then passes through the cooling section 28, in which it is quenched by means of the reducing protective gas. Here, the grain-oriented electrical steel strip 48 is cooled at an initial cooling rate of 40 K/s to a temperature of 420° C. and subsequently at a cooling rate of less than 20 K/s to an exit temperature of 130° C. The non-grain-oriented electrical steel strip 49, on the other hand, is constantly cooled at a cooling rate of 25 K/s to an exit temperature of 130° C.

FIG. 4 shows a heat treatment temperature profile for a hot-rolled steel strip 3, which is subsequently provided for the production of a stainless steel strip 50.

The hot-rolled steel strip 3 of an austenitic grade AISI 300 provided for the production of the stainless steel strip 50 has a width of 1280 mm and a strip thickness of 2600 μm in the present exemplary embodiment and is subjected to an oxidation-free heat treatment in an annealing device 1 at a strip speed of 80 m/min. In contrast to the annealing device 1 shown in FIG. 1, the furnace chamber 4 is formed by the heating section 7 along with the cooling section 28, wherein the heating section 7 also has only one row of transverse field inductors 10, 11. The hot-rolled steel strip 3, previously pickled in the pre-treatment device 38, is also fed through the entry sluice 5 into the furnace chamber 4, which has a reducing protective gas atmosphere with a hydrogen content of 75% by volume. The hot-rolled steel strip 3 initially passes through the heating section 7, in which it is heated to the annealing temperature of 1050° C. by means of the transverse field inductors 10, 11. The briefly annealed steel strip 3 subsequently passes through the cooling section 28, in which it is cooled to an exit temperature of 80° C. by means of the reducing protective gas at a constant cooling rate of 18 K/s.

### REFERENCE SIGNS

1 Annealing device/annealing furnace
2 Treatment line
3 Hot-rolled steel strip/hot strip
4 Furnace chamber
5 Entry sluice
6 Exit sluice
7 Heating section
8 Inductor/longitudinal field inductor
9 Inductor/longitudinal field inductor
10 Inductor/transverse field inductor
11 Inductor/transverse field inductor
12 First stage
13 Second stage
14 Longitudinal field inductor coil
15 Transverse field inductor coil
16 Steel strip feed-through level
17 Thermal insulation layer
18 Thermal insulation layer
19 Gas-tight enclosure
20 Passage gap
21 Roller stand
22 Holding section
23 First holding section stage
24 Second holding section stage
25 Third holding section stage
26 Heating elements
27 Cooling jet pipe
28 Cooling section
29 Cooling device
30 First cooling stage
31 Second cooling stage
32 Distributor
33 Distributor
34 Blower device/fan
35 Blower device/fan
36 Heat exchanger
37 Heat exchanger
38 Pre-treatment device
39 First coil device
40 Hot strip coil
41 First cutting device
42 Welding device
43 Trimming device
44 Inlet accumulator
45 Outlet accumulator
46 Second cutting device
47 Second coil device
48 Annealing treatment of grain-oriented electrical steel strip
49 Annealing treatment of non-grain-oriented electrical steel strip
50 Annealing treatment of stainless steel strip
100 Protective gas feed

1.-17. (canceled)

18. An annealing device (1) for oxidation-free heat treatment of a hot-rolled steel strip (3), comprising:
a hermetically sealed furnace chamber (4), including
a heating section (7), and
a cooling section (28) following the heating section (7),
wherein the heating section (7) comprises a plurality of inductors (8, 9, 10, 11) connected in series,
wherein the cooling section (28) comprises a cooling device (29), and
wherein a reducing protective gas for cooling the hot-rolled steel strip (3) can be introduced into the cooling section (28) via cooling device (29).

19. The annealing device (1) according to claim 18, further comprising
a holding section (22) following the heating section (7),
wherein the cooling section follows the holding section (22),
wherein the annealing device (1) is an annealing furnace,
wherein the annealing device (1) is configured for use in a treatment line (2) for continuous pickling and oxidation-free annealing of the hot-rolled steel strip (3), and
wherein the hot-rolled steel strip (3) is provided for producing an electrical steel strip and/or a stainless steel strip.

20. The annealing device (1) according to claim 18,
wherein the cooling device (29) comprises at least one nozzle, and
wherein the reducing protective gas can be blown onto the hot-rolled steel strip (3) through the at least one nozzle.

21. The annealing device (1) according to claim 20,
wherein the cooling device (29) comprises at least one blower device (34, 35), and
wherein the reducing protective gas is fed to the at least one nozzle by the at least one blower device (34, 35).

22. The annealing device (1) according to claim 21,
wherein the cooling device (29) comprises at least one heat exchanger (36, 37), and
wherein the reducing protective gas blown into the cooling section (28) is cooled by the at least one heat exchanger (36, 37).

23. The annealing device (1) according to claim 22,
wherein the cooling device (29) has a circulation system,
wherein the at least one nozzle, the at least one blower device (34, 35), and the at least one heat exchanger (36, 37) are interconnected by the circulation system in such a manner that the reducing protective gas is blown into the cooling section (28) via the at least one blower device (34, 35) through the at least one nozzle onto the hot-rolled steel strip (3), and is extracted again via the at least one blower device (34, 35) and cooled by the at least one heat exchanger (36, 37).

24. The annealing device (1) according to claim 18,
wherein the heating section (7) comprises
a first stage (12) with a plurality of longitudinal field inductors (8, 9) connected in series, and
a second stage (13) with a plurality of transverse field inductors (10, 11) connected in series.

25. The annealing device (1) according to claim 18,
wherein the heating section (7) has a passage gap (20) for the hot-rolled steel strip (3), and
wherein the passage gap (20) is delimited by a thermal insulation layer (17, 18).

26. The annealing device (1) according to claim 25,
wherein the passage gap (20) has a vertical extension of ≤250 mm.

27. A treatment line (2), comprising:
a pre-treatment device (38), in which the hot-rolled steel strip (3) can be pickled; and
the annealing device (1) according to claim 18, arranged downstream of the pre-treatment device (38).

28. A method for continuous pickling and oxidation-free annealing of a hot-rolled steel strip (3) for producing electrical steel strip and/or stainless steel strip, comprising:
feeding the hot-rolled steel strip (3) to a pre-treatment device (38);
pickling the hot-rolled steel strip (3) in the pre-treatment device (38) thereby producing a pickled steel strip (3);
feeding the pickled steel strip (3) to an annealing device (1);
inductively heating, under a reducing protective gas atmosphere, the pickled steel strip (3) to an annealing temperature in an annealing device (1) via a plurality of inductors (8, 9, 10, 11) connected in series;
annealing the pickled steel strip (3) thereby producing an annealed steel strip; and
subsequently quenching and/or cooling the annealed steel strip (3) using a reducing protective gas.

29. The method according to claim 28, further comprising:
unwinding the hot-rolled steel strip (3) before feeding the hot-rolled steel strip (3) to the pre-treatment device (38).

30. The method according to claim 28,
wherein inductively heating the pickled steel strip (3) is performed in a heating section (7) of the annealing device (1) to the annealing temperature of at least 800° C. at a heating rate of at least 20 K/s.

31. The method according to claim 30,
wherein annealing the pickled steel strip (3) is performed in a holding section (22) of the annealing device (1) following the heating section (7) at a temperature in a range of 800-1200° C. for at least 60 seconds.

32. The method according to claim 30, further comprising
cooling the annealed steel strip (3) at an initial cooling rate of at least 15 K/s in a cooling section (28) of the annealing device (1) following the heating section (7).

33. The method according to claim 30,
wherein heating the pickled steel strip (3) in the heating section (7) is performed in two stages (12, 13) by
initially heating the pickled steel strip (3) in a first stage (12) to a temperature of at least 650° C. and
subsequently heating the pickled steel strip (3) in a second stage (13) to the annealing temperature of at least 800° C.

34. The method according to claim 33,
wherein the pickled steel strip (3) is heated in the first stage (12) by a plurality of longitudinal field inductors (8, 9) connected in series and
wherein the pickled steel strip (3) is heated in the second stage (13) by a plurality of transverse field inductors (10, 11) connected in series.

35. The method according to claim 32, further comprising:
cooling the annealed steel strip (3) in the cooling section (28) of the annealing device (1) by a cooling device (29),
wherein the reducing protective gas is blown onto the annealed steel strip (3) via the cooling device, and
wherein the reducing protective gas is extracted from the cooling section (28) via a blower device (34, 35) and cooled via a heat exchanger (36, 37).

36. The method according to claim 28,
wherein the reducing protective gas is a hydrogen-rich gas that has a hydrogen content of at least 50% by volume.
